(19) United States
(12) Patent Application Publication
(10) Pub. No.: US 2013/0200983 A1
(43) Pub. Date: Aug. 8, 2013

(54) THERMAL OVERLOAD PROTECTION APPARATUS

(71) Applicants: Thomas Meyer, Ottenstein (DE); Steffen Pfortner, Springe (DE); Peter Berg, Schlangen (DE)

(72) Inventors: Thomas Meyer, Ottenstein (DE); Steffen Pfortner, Springe (DE); Peter Berg, Schlangen (DE)

(73) Assignee: PHOENIX CONTACT GMBH & CO. KG, Blomberg (DE)

(21) Appl. No.: 13/814,527

(22) PCT Filed: Aug. 5, 2011
(86) PCT No.: PCT/EP11/63517

§ 371 Date: Apr. 19, 2013

(30) Foreign Application Priority Data
Aug. 6, 2010 (EP) 10 2010 036 907
Oct. 8, 2010 (EP) 10 2010 038 070

(51) Int. Cl. H01H 85/36

(52) U.S. Cl. CPC H01H 85/36
USPC 337/147; 337/143; 337/150

(57) ABSTRACT

A thermal overload protection apparatus for protection of an electrical component is disclosed. In one exemplary implementation, such apparatus may comprise a switching element for short-circuiting or disconnecting electrical connections, an actuator apparatus for switching the switching element to a short-circuit or disconnect position, and a tripping element which trips the actuator apparatus on a thermally sensitive basis. In some implementations, the actuator apparatus may be configured to be switched over for activation from an inactive state, in which the switching element cannot be switched by the actuator apparatus, into a trippable state, in which the switching element is capable of being switched by the actuator apparatus. Innovations herein also relate to corresponding arrangements having a conductor track mount, at least one component arranged thereon, and at least one associated overload protection apparatus.

The invention relates to a thermal overload protection apparatus for protecting an electrical component, in particular an electronic component, said thermal overload protection apparatus having a switching element for short-circuiting connection points of the component or for disconnecting an electrically conductive connection between at least one of the connection points and a current-carrying element of the overload protection apparatus, an actuator apparatus for switching the switching element to an appropriate short-circuiting position or disconnection position, and a tripping element which trips the actuator apparatus on a thermally sensitive basis.

An overload protection apparatus of this type is known for example from Offenlegungsschrift DE 10 2008 022 794 A1. That document describes a thermal overload protection apparatus, which has a short-circuit device with spring-biased shorting bar for short-circuiting electrodes of a surge arrester, and a fusible element tripping the overload protection apparatus. In addition to this embodiment as an overload protection apparatus with switching element of a short-circuit device, an overload protection apparatus with corresponding switching element of a disconnection device is also conceivable.

The overload of electronic components may result in said components operating outside a nominal operating range. In this case, a power conversion at a damaged component, caused for example by a reduced insulation strength of the component, leads to increased heating.

If a heating of the component above a permissible threshold is not prevented, this may lead, for example, to damage of surrounding materials, production of waste gases or to a risk of fire.

These risks are also present with an arrangement of components arranged on a conducting track support, such as surface-mountable components. To construct an arrangement of this type, the conducting track support (the printed circuit board/PCB) is fitted with suitable components and soldered, generally by automatons. Due to this fitting process, there is often only a very limited amount of installation space. At the same time, temperatures are produced locally, which reach at least close to the trip temperature of the tripping element.

The object of the invention is to specify a thermal overload protection apparatus, which requires little installation space, responds reliably to thermal overload and short circuits or disconnects, and can be integrated easily, in spite of the temperatures produced, in a mounting process of a mounting operation, in particular surface-mounting, of components on a conducting track support.

This object is achieved in accordance with the invention by the features in the independent claim. Advantageous embodiments of the invention are disclosed in the dependent claims.

With the overload protection apparatus according to the invention, the actuator apparatus can be switched over for activation from an inactive state, in which the switching element cannot be switched by the actuator apparatus, not even as a result of tripping by means of the tripping element, into a trippable state, in which the switching element can be switched by the actuator apparatus trippable by means of the tripping element. The terms “inactive” and “trippable” thus mean in this context that only the actuator apparatus activated by the switchover applies a force required for short-circuiting or disconnection during a tripping process and the inactivated, that is to say inactive, actuator apparatus does not apply any force, or does not apply a force sufficient, for short-circuiting or disconnection, not even in the event of tripping by means of the tripping element. An overload protection apparatus of this type can be mounted without the risk of tripping, even by means of a mounting type associated with high temperatures, such as soldering. Activation only once an uncritical temperature has been reached or at any other selectable moment in time is thus made possible. In particular, this moment in time may be once mounting of the overload protection apparatus and/or the electrical component is complete.

The component is preferably a component that can be mounted or is mounted via its connection points on a conducting track support comprising conducting tracks. The current-carrying element of the electrically conductive connection in an electrical switching element formed as a disconnection element is, in particular, one of the conducting tracks or a current-carrying element mounted on the conducting track support and connected to one of the conducting tracks. The electrically conductive connection is a connection for connecting the component. The short circuit is, in particular, a short circuit via at least one of the conducting tracks.

The tripping element is advantageously formed as a fusible element tripped by melting. The melting point of the fusible element determines the trip temperature, which can thus be set via the material selection. The fusible element has solder or a hot-melt plastic for example as active material.

Compared to a solder, hot-melt plastic demonstrates a softer transition of its consistency at the melting point. This has the advantage that a tripping element made of hot-melt plastic remains in its original location, even in the event of tripping, and its shape is merely changed by the tripping operation in such a way that the short-circuit device can short circuit the component.

If the switching element is formed as a disconnection device for disconnecting an electrically conductive connection of at least one of the connection points to a current-carrying element, the fusible element is thus preferably a soldered connection within the electrically conductive connection (to be disconnected).

In accordance with a preferred embodiment of the invention, the actuator apparatus is an actuator apparatus that can be switched over by manually changing the outer form of the actuator apparatus or the arrangement of the actuator apparatus relative to the switching element. The switchover is thus a manual switchover by changing the outer, form of the actuator apparatus or by changing the arrangement of the actuator apparatus relative to the switching element. The activation may be undertaken directly at the overload protection apparatus. The moment of the activation can be selected freely by a user.

In accordance with an advantageous embodiment of the invention, the actuator apparatus has at least one spring element, and in particular is a spring element. The actuator apparatus is switched over by biasing the spring element.

In particular, the spring element in this case is a snap dome or has a snap dome. Snap domes are spring elements that function in accordance with the clicker principle. A clicker is a spring element that consists of a strip of spring steel. The steel is stamped such that it has a stable state and a metastable state. It is bent as a result of the influence of force in the stable state until it suddenly springs into the metastable state by denting. The spring element of the clinker generally has a dome-like or dome-portion-like region, which is produced by the stamping process. The two states are preferably used in this embodiment of the invention to produce a relaxed state and a biased state of the spring element. In this case the switchover is a switchover from the untensioned state into the biased state.

As active material, the actuator apparatus may alternatively or additionally advantageously have an intumescent material and/or a shape-memory material and/or a material of chemically changing form.

In particular, the actuator apparatus in the switched-over state is an actuator apparatus mechanically biased by means of a latch at the switching element. Parts of the actuator apparatus and/or of the switching element are therefore latched to one another when the actuator apparatus is switched over or are otherwise actively engaged with one another so as to bias the actuator apparatus.

The actuator apparatus is alternatively or additionally advantageously a device that can be switched over (and therefore activated) by means of reciprocal displacement of parts or regions of the actuator apparatus. If the actuator apparatus has a spring element functioning by the clicker principle (a snap dome), the displacement is thus a denting of a region of this spring element.

In accordance with a development of the invention, the switching element and the actuator apparatus are formed in one piece or at least comprise a common part formed in one piece. This reduces the number of required parts and provides a clear connection between the switching element and actuator apparatus.

In accordance with a preferred embodiment of the invention, the component is a component that can be separated from the overload protection apparatus, in particular from the switching element. The component and overload protection apparatus can therefore be manipulated independently of one another, at least in principle. In particular, this degree of freedom simplifies the mounting of the component and/or overload protection apparatus.

The invention further relates to an arrangement comprising a conducting track support, at least one component arranged thereon and at least one overload protection apparatus as described above. The component is preferably a surge arrester, in particular on a semiconductor basis (suppressor diode, varistor, etc.) or a gas-filled surge arrester or a resistor.

In particular, the component is a surface-mounted component (SMD component), which is preferably mounted on the conducting tracks of the conducting track support by means of a reflow soldering process.

In accordance with a preferred embodiment of the invention, the switching element and/or the actuator apparatus of the overload protection apparatus is supported on the component via the tripping element (that is to say indirectly) or via a conducting track of the conducting track support connected directly to a connection point of the component. In particular, the switching element and/or the actuator apparatus of the overload protection apparatus is alternatively or additionally supported directly on at least one conducting track contacting one of the connection points.

The invention will be explained in greater detail hereinafter with reference to the accompanying drawing on the basis of preferred embodiments, in which:

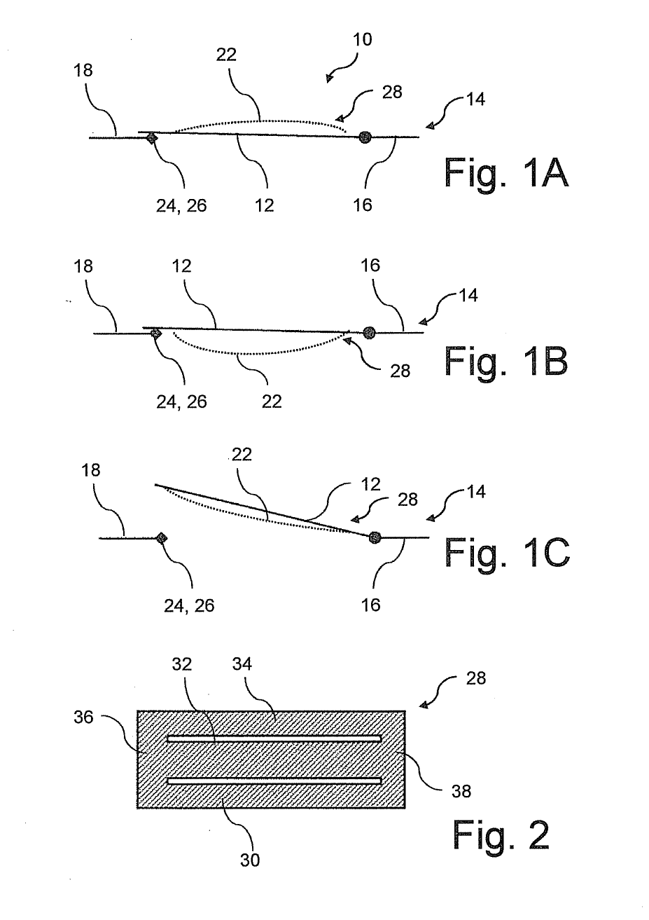

FIGS. 1A-1C show a schematic illustration of a thermal overload protection apparatus for separating an electrical connection in accordance with a first embodiment,

FIG. 2 shows a plan view of the actuator apparatus of the thermal overload protection apparatus in FIGS. 1A-1C,

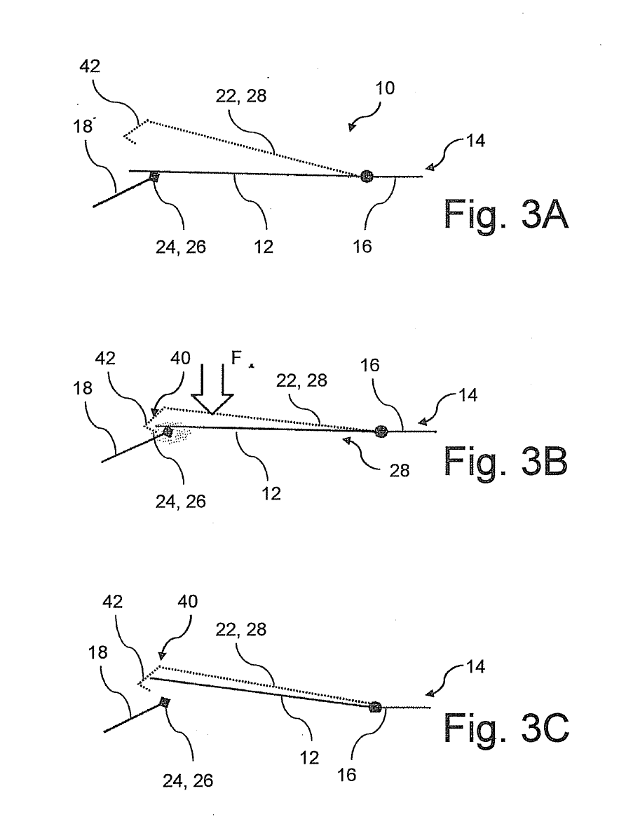

FIGS. 3A-3C show a schematic illustration of a thermal overload protection apparatus for separating an electrical connection in accordance with a second embodiment,

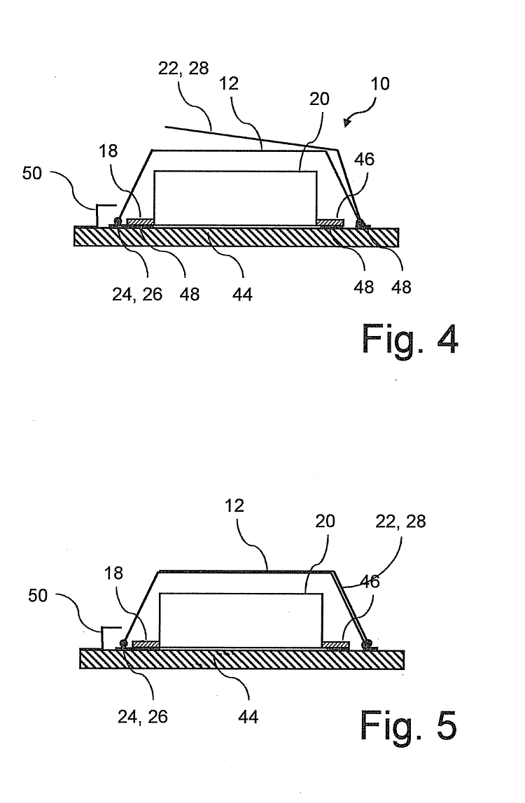

FIG. 4 shows an electronic component and a thermal overload protection apparatus in the inactive operating state in accordance with a third embodiment of the invention,

FIG. 5 shows the component and the thermal overload protection apparatus of FIG. 4 in the activated operating state,

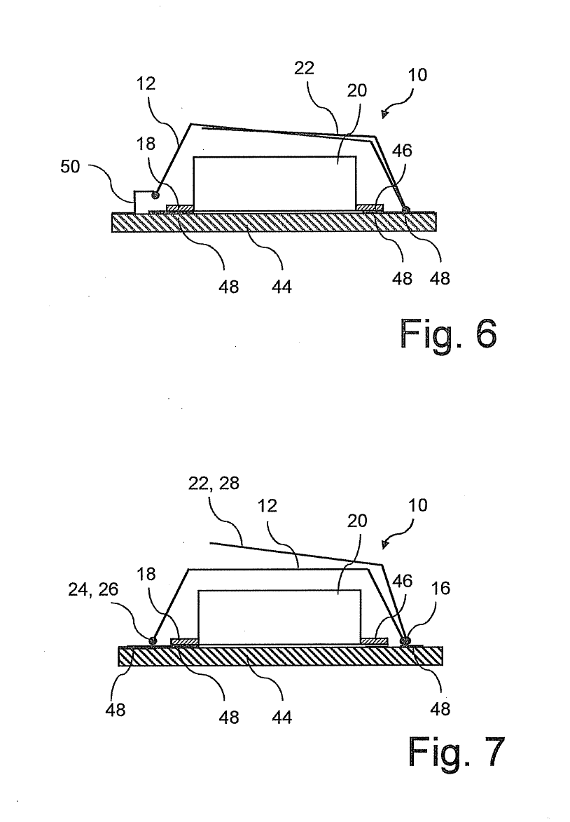

FIG. 6 shows the component and the thermal overload protection apparatus of FIGS. 4 and 5 in the tripped operating state,

FIG. 7 shows an electronic component and a thermal overload protection apparatus in the inactive operating state in accordance with a fourth embodiment of the invention,

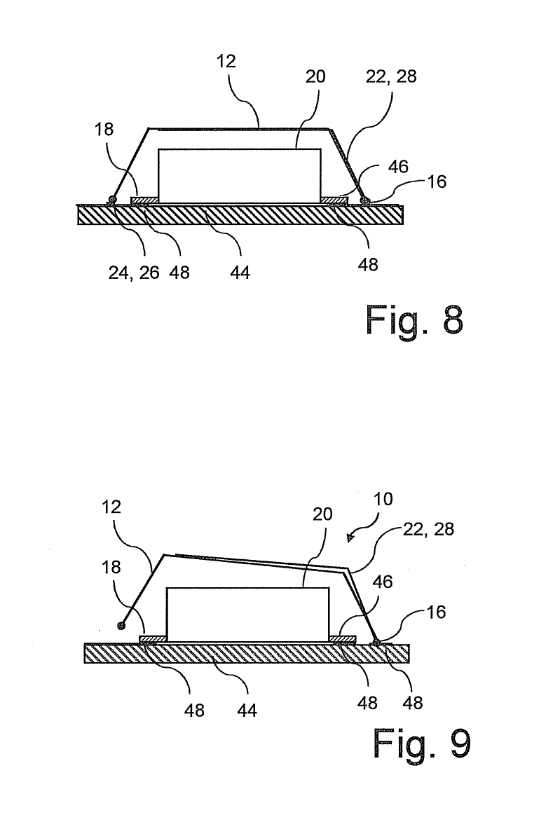

FIG. 8 shows the component and the thermal overload protection apparatus of FIG. 7 in the activated operating state, and

FIG. 9 shows the component and the thermal overload protection apparatus of FIGS. 7 and 8 in the tripped operating state.

FIGS. 1A to 1C show a schematic illustration of part of a thermal overload protection apparatus 10. This part comprises a switching element 12 for disconnecting an electrically conductive connection 14 between a current-carrying element 16 and a connection point 18 of an electrical component 20 shown in the specific exemplary embodiments of FIGS. 4 to 9. This part further comprises an actuator apparatus 22 and a tripping element 24, which trips the actuator apparatus 22 on a thermally sensitive basis. This tripping element 24 is formed as a fusible element 26 in the example of FIGS. 1A to 1C. This fusible element 26 is a soldered connection within the electrically conductive connection 14, wherein the soldered connection enables a flow of current through the connected connection 16.

FIG. 1A shows the electrically conductive connection 16 with the switching element 12 and the actuator apparatus 22 in an inactive state, in which the switching element 12 cannot be switched or is not switched by the actuator apparatus 22, not even as a result of tripping by means of the tripping element 24, since the actuator apparatus is force-free in this state (F=0N). The actuator apparatus 22 is formed in this case as a spring element 28 functioning by the clicker principle. Parts of this spring element 28 are also used simultaneously as the switching element 12. The switching element 12 and actuator apparatus 22 are thus formed as a one-piece spring element 28.

FIG. 2 shows this spring element 28 in a plan view. The spring element 28 has three strip-shaped regions 30, 32, 34, which run parallel to one another and are fixedly interconnected at their respective ends via end regions 36, 38 of the spring element 28. At least one of the strip-shaped regions 32 is longer than the other strip-shaped regions 30, 34 (for example as a result of stamping). These other strip-shaped regions 30, 34 are completely planar for example, whereas the longer strip-shaped region (for example the central region) 32 bulges in a preferred direction as a result of the stamping. By pressing the longer strip-shaped region 32 so that it dents in the opposite direction, the spring element 28 can then be switched over from one state into the other state, in which it dents, at least in some regions, in the other direction. One state is the force-free state with F=0N, and the spring element 28 is biased in the other state. Although the shown spring element 28 is not a snap dome, it therefore still has the same operating principle, namely the operating principle of what is known as a clicker.

One end region 36 of the spring element 28 is simultaneously an end region 36 of the switching element 12 and, as such, is connected to the connection point 18 in the connected state by means of the fusible element 26 formed as a soldered connection. The other end region 38 of the spring element 28 is simultaneously the other end region 38 of the switching element 12 and, as such, is permanently connected to the current-carrying element 16.

FIG. 1B shows the electrically conductive connection 16 with the switching element 12 and the actuator apparatus 22 after a switchover into a trippable state, in which the switching element 12 can be switched by the actuator apparatus 22 trippable by means of the tripping element 24. FIG. 1C shows the separated connection 16 with the switching element 12 and the actuator apparatus 22 after a switchover into the trippable state, in which the switching element 12 can be switched by the actuator apparatus 22 trippable by means of the tripping element 24, and after a subsequent tripping by the tripping element 24.

The biased central strip-shaped region 32 of the spring element 28 draws one end region 36 away from the fusible element 26, so that the electrically conductive connection 14 is separated.

The part of the thermal overload protection apparatus 10 shown in FIGS. 3A to 3C corresponds substantially to the overload protection apparatus 10 of FIGS. 1A to 1C, and therefore only the differences will be discussed here.

FIG. 3A shows the electrically conductive connection 16 with the switching element 12 and the actuator apparatus 22 in an inactive state, in which the switching element 12 cannot be switched or is not switched by the actuator apparatus 22, not even by tripping by means of the tripping element 24, since the actuator apparatus does not exert any disconnecting force onto the switching element 12 in this state (F=0N). The tripping element 24 is also formed in this case as a fusible element 26.

FIG. 3B shows the electrically conductive connection 16 with the switching element 12 and the actuator apparatus 22 after a switchover into a trippable state, in which the switching element 12 can be switched by the actuator apparatus 22 trippable by means of the tripping element 24. The actuator apparatus 22 is pivoted/bent relative to the switching element 12 by means of the force to be applied manually (arrow F), such that the actuator apparatus 22 is mechanically biased by means of a latch 40 at the switching element 12 and is thus switched over into the other state. The actuator apparatus 22 is formed in this embodiment as a “normal” spring element 28 and has a structure 42 for engagement from behind to form the latch 40, said structure engaging one end region of the switching element 12 from behind.

FIG. 3C shows the disconnected connection 16 with the switching element 12 and the actuator apparatus 22 after switchover into the trippable state, in which the switching element 12 can be switched by the actuator apparatus 22 trippable by means of the tripping element 24 (FIG. 3B), and after the subsequent tripping by the tripping element 24. The biased spring element 28 of the actuator apparatus 22 draws one end region 36 away from the fusible element 26, so that the electrically conductive connection 14 is disconnected.

FIGS. 4 to 6 and 7 to 9 show the overload protection apparatus 10 in the context of an arrangement of the electrical component 20 mounted on a conducting track support (in particular a printed circuit board, PCB) 44. The component 20 is formed in this case as a surface-mountable electronic component, which is electrically contacted via its connection points 18, 46 to the conducting tracks 48 of the conducting track support 44 by means of a reflow soldering method.

FIGS. 4 to 6 show an arrangement in which, in the event of thermal overload, the overload protection arrangement 10 short-circuits the connection points 18, 46 by means of the switching element 12 formed as a shorting bar. The electrically conductive switching element 12 is arranged relative to the component 20. The switching element 12 is fastened on the support 44. An end region 36 of the switching element 12 forms an electrical switch together with a current-carrying element 50 fastened on the support 44 and formed as short-circuit metal.

In this case, FIG. 4 shows the overload protection arrangement 10 with the switching element 12 and the actuator apparatus 22 in an inactive state, in which the switching element 12 cannot be switched or is not switched by the actuator apparatus 22, not even by tripping by means of the tripping element 24, since the actuator apparatus does not exert any force onto the switching element 12 in this state. The tripping element 24 is also formed in this case as a fusible element 26.

FIG. 5 shows the overload protection arrangement 10 with the switching element 12 and the actuator apparatus 22 after a switchover into the trippable state, in which the switching element 12 can be switched by the actuator apparatus 22 trippable by means of the tripping element 24. The actuator apparatus 22 is mechanically biased relative to the switching element 12 by means of the force to be applied manually, such that the actuator apparatus 22 is mechanically biased by means of a latch (not shown) at the switching element 12 and is thus switched over into the trippable state. The actuator apparatus 22 is formed in this embodiment as a spring element 28.

FIG. 6 shows the component 20, short-circuited by means of the switching element 12 formed as a shorting bar, after the tripping by the tripping element 24. The biased spring element 28 of the actuator apparatus 22 draws one end region away from the fusible element 26, so that the short circuit (not shown) is produced via the hook-shaped current-carrying element 50 and suitable conducting tracks.

The following advantages are provided: The overload protection apparatus 10 is force-free in the mounted state. The overload protection apparatus can be mounted on the support 44 simply by being fitted, in particular by means of a fitting automaton. No fixing or holding-down is necessary for the soldering process. The apparatus can be activated by reciprocal latching (or denting) of the switching element 12 and spring element 28 after the mounting/the soldering process.

In the operating state, the switch formed by the spring element 28 and contacting point with the fusible element 26 on the support 44 is opened. Inadmissible heating of the component 20 above the activation temperature leads to an activation of the apparatus 10 situated in the trippable state. If the activation temperature (solder melting point) is exceeded, the tension of the spring element 28 closes the switch thus formed and the component 20 is thus converted into a safe state.

FIGS. 7 to 9 show an arrangement in which the overload protection arrangement 10 disconnects the electrically conductive connection 14 between one of the connection points 18 and a current-carrying element 16 of the overload protection apparatus 10 in the event of thermal overload. This arrangement corresponds substantially to the arrangement described in FIGS. 3A to 3C.

The electrically conductive switching element 12 is arranged relative to the component 20. The switching element 12 is fastened on the support 44. One end region 36 of the switching element 12 forms an electrical switch together with a contacting point on the support 44.

FIG. 7 shows the overload protection arrangement 10 with the switching element 12 and the actuator apparatus 22 in an inactive state, in which the switching element 12 cannot be switched or is not switched by the actuator apparatus 22, not even by tripping by means of the tripping element 24, since the actuator apparatus does not exert any force onto the switching element 12 in this state. The tripping element 24 is also formed in this case as a fusible element 26.

FIG. 8 shows the electrically conductive connection 16 with the switching element 12 and the actuator apparatus 22 after a switchover into a trippable state, in which the switching element 12 can be switched by the actuator apparatus 22 trippable by means of the tripping element 24. The actuator apparatus 22 is bent relative to the switching element 12 by means of force to be applied manually, such that the actuator apparatus 22 is mechanically biased by means of a latch 40 at the switching element 12 and is thus switched over into the other state. The actuator apparatus 22 has a structure 42 for latching from behind to form the latch 40, said structure engaging an end region of the switching element 12 from behind (not shown).

FIG. 9 shows the disconnected connection 16 with the switching element 12 and the actuator apparatus 22 after a switchover into the trippable state, in which the switching element 12 can be switched by the actuator apparatus 22 trippable by means of the tripping element 24, and after a subsequent tripping by the tripping element 24. The biased spring element 28 of the actuator apparatus 22 draws one end region away from the fusible element 26, so that the electrically conductive connection 14 is separated.

The following advantages are provided: The overload protection apparatus 10 is force-free in the mounted state. The overload protection apparatus can be mounted on the support 44 simply by being fitted, in particular by means of a fitting automaton. No fixing or holding-down is necessary for the soldering process. The apparatus can be activated by reciprocal latching (or denting) of the switching element 12 and spring element 28 after the mounting/the soldering process.

In the operating state, the switch formed by the spring element 28 and contacting point with the fusible element 26 on the support 44 is closed. Inadmissible heating of the component 20 above the activation temperature leads to an activation of the apparatus 10 situated in the trippable state. If the activation temperature (solder melting point) is exceeded, the tension of the spring element 28 opens the switch thus formed and the component 20 is thus converted into a safe state.

List of reference signs

| | |
|---|---|
| overload protection apparatus | 10 |
| switching element | 12 |
| conductive connection | 14 |
| current-carrying element | 16 |
| connection point | 18 |
| component | 20 |
| actuator apparatus | 22 |
| tripping element | 24 |
| fusible element | 26 |
| spring element | 28 |
| strip-shaped region | 30 |
| strip-shaped region | 32 |
| strip-shaped region | 34 |
| end region | 36 |
| end region | 38 |
| latch | 40 |
| structure for engagement from behind | 42 |
| conducting track support | 44 |
| connection point | 46 |
| conducting track | 48 |
| current-carrying element | 50 |
| arrow | F |

1. A thermal overload protection apparatus for protecting an electrical component, said thermal overload protection apparatus comprising:
a switching element for short-circuiting connection points of the component or for disconnecting an electrically conductive connection between at least one of the connection points and a current-carrying element of the overload protection apparatus,
an actuator apparatus for switching the switching element to an appropriate short-circuiting position or disconnection position, and
a tripping element which trips the actuator apparatus on a thermally sensitive basis,
wherein the actuator apparatus is configured to be switched over for activation from an inactive state, in which the switching element cannot be switched by the actuator apparatus, not even as a result of tripping via the tripping element, into a trippable state, in which the switching element is capable of being switched by the actuator apparatus.

2. The overload protection apparatus according to claim 1, wherein the tripping element is formed as a fusible element tripped by melting.

3. The overload protection apparatus according to claim 1, wherein the actuator apparatus is an actuator apparatus that can be switched over by manually changing the outer form of the actuator apparatus or the arrangement of the actuator apparatus relative to the switching element.

4. The overload protection apparatus according to claim 1, wherein the actuator apparatus has at least one spring element.

5. The overload protection apparatus according to claim 4, wherein the spring element is a snap dome.

6. The overload protection apparatus according to claim 1, wherein the actuator apparatus has an intumescent material and/or a shape-memory material and/or a material of chemically changing form.

7. The overload protection apparatus according to claim 1, wherein the actuator apparatus is an actuator apparatus mechanically biased by means of a latch at the switching element in the switched-over state.

8. The overload protection apparatus according to claim 1, wherein the switching element and the actuator apparatus are formed in one piece or comprise at least one common part formed in one piece.

9. The overload protection apparatus according to claim 1, wherein the component is a component that can be separated from the overload protection apparatus.

10. An arrangement comprising a conducting track support, at least one component arranged thereon and at least one overload protection apparatus according to claim 1.

11. The arrangement according to claim 10, wherein the switching element and/or the actuator apparatus of the overload protection apparatus is/are supported on the component via the tripping element or via a conducting track of the conducting track support connected directly to a connection point of the component.

12. The arrangement according to claim 10, wherein the switching element and/or the actuator apparatus of the overload protection apparatus is/are supported directly on least one conducting track contacting one of the connection points.

13. The arrangement according to claim 11, wherein the switching element and/or the actuator apparatus of the overload protection apparatus is/are supported directly on least one conducting track contacting one of the connection points.

14. The overload protection apparatus according to claim 9, wherein the component is a component that can be separated from the switching element.

15. The overload protection apparatus according to claim 2, wherein the actuator apparatus is an actuator apparatus that can be switched over by manually changing the outer form of the actuator apparatus or the arrangement of the actuator apparatus relative to the switching element.

16. The overload protection apparatus according to claim 2, wherein the actuator apparatus has at least one spring element.

17. The overload protection apparatus according to claim 16, wherein the spring element is a snap dome.

18. The overload protection apparatus according to claim 2, wherein the actuator apparatus has an intumescent material and/or a shape-memory material and/or a material of chemically changing form.

19. The overload protection apparatus according to claim 2, wherein the actuator apparatus is an actuator apparatus mechanically biased by a latch at the switching element in the switched-over state.

20. The overload protection apparatus according to claim 2, wherein the switching element and the actuator apparatus are formed in one piece or comprise at least one common part formed in one piece.
